(19) United States
(12) Patent Application Publication
(10) Pub. No.: US 2014/0014209 A1
(43) Pub. Date: Jan. 16, 2014

(54) SANITARY FITTING

(71) Applicant: HANSGROHE SE, SCHILTACH (DE)

(72) Inventors: Jürgen King, Lauterbach (DE); Jörg WERNER, Schramberg (DE)

(21) Appl. No.: 13/938,704

(22) Filed: Jul. 10, 2013

(30) Foreign Application Priority Data
Jul. 13, 2012 (DE) 10 2012 212 302.4

(51) Int. Cl. F16L 55/00

(52) U.S. Cl. CPC F16L 55/00
USPC 137/798

(57) ABSTRACT

A system of sanitary fittings is proposed with differing fitting housings, where the arrangement of a receptacle in the fitting housing for receiving of a mixer cartridge differs from housing to housing. For compensation of the differing arrangement of the receptacles, an adapter insert adapted to the specific arrangement is inserted into the housing through the receptacle for the mixer cartridge. This adapter insert interacts with the always identical connecting insert for connection of the supply lines.

The invention relates to a sanitary fitting having a fitting housing.

A sanitary fitting having a pipe-like fitting housing is already known. The fitting housing contains a mixer cartridge. The fitting housing is fastened to a base area. The supply lines pass through the base area. For adaptation to differing mixer cartridges, a replaceable intermediate element is provided in the fitting housing and is connected on one side to the supply lines and on the other side to the mixer cartridge or to an outlet from the fitting housing (DE 100 11 505 A1).

In the known sanitary fitting, the mixer cartridge is arranged at the end of the pipe-like fitting housing. There are however also sanitary fittings where the mixer cartridge is arranged in a lateral branch or in a bend of an otherwise pipe-like fitting housing.

The object underlying the invention is to provide a possibility of managing with as few basic components as possible in sanitary fittings with lateral cartridge receptacles of differing design.

To attain this object, the invention proposes a sanitary fitting having the features stated in claim 1. Further embodiments of the invention are the subject-matter of sub-claims.

Whereas in the prior art an intermediate element is arranged between the supply lines and the mixer cartridge, the invention splits the adaptation into two parts. The connecting insert is used for attachment and connection of the supply lines and if necessary also for a discharge line through the fastening surface of the fitting housing, and the adapter insert is used for adaptation to the mixer cartridge and/or to the geometric design of the housing part in which the receptacle for the mixer cartridge is arranged.

For example, the fitting housing can be angled or curved, where the angles thereof can vary. In this case, an adaptation to this course can be achieved with the aid of two inserts, and is not possible with a single insert.

In particular, the invention can be applied for a fitting housing where the receptacle for the mixer cartridge is arranged in a branch of the fitting housing. Here too, the branch can have differing angles, which can then be compensated for by differing adapter inserts. The differing adapter inserts can also be used for mixer cartridges of differing size or for mixer cartridges of differing function.

In a development of the invention, it can be provided that the connecting insert has a lateral separation surface facing the branch of the fitting housing, which contacts the adapter insert with its separation surface. In this way, branches in any angles can be realized.

It can be provided in a development in accordance with the invention that the adapter insert forms the bottom for the cartridge.

The connecting insert has on its one end face, i.e. that facing in the direction of the fastening surface, at least one connection for a supply line. It can be provided in a development in accordance with the invention that the connecting insert has on the opposite end face a connection for a line leading out of the sanitary fitting. For example, a line there can lead to an outlet from the fitting.

It can be provided in particular that the connection for the line leading out of the sanitary fitting is a plug-in connection.

It can be provided in accordance with the invention that the connecting insert can be pushed into the interior of the fitting housing from the supply line side, i.e. from the fastening surface of the fitting housing, preferably with supply line already attached to it.

The adapter insert can be designed in a development such that it can be inserted into the interior of the fitting housing through the receptacle for the mixer cartridge.

It has proven to be particularly useful when the connecting insert in its set position interacts with the adapter insert such that it ensures a mechanical locking of the connecting insert in the fitting housing and hence also a mechanical locking of the adapter insert.

It can be provided in accordance with the invention that the adapter insert and/or the connecting insert consist of a plastic, as does the line leading out of the sanitary fitting. This is preferably a plastic harmless to health, so that the water flowing through the fitting does not come into contact with metal at any point, even if the fitting housing itself consists of metal.

The invention can also be used when the fitting housing itself consists of plastic.

The invention also proposes a system of sanitary fittings with differing fitting housings, differing forms of the receptacle for the mixer cartridge, differing mixer cartridges and differing adapter inserts, but always the same connecting insert.

The adapters can adapt to or compensate for differing angles and/or differing cartridge diameters.

The invention furthermore proposes the use of an adapter insert to compensate for the differing arrangement of the receptacle for a mixer cartridge relative to a connecting insert.

Further features, details and advantages of the invention are shown in the claims and in the abstract, the wordings of both of which are made into the substance of the description by reference, in the following description of preferred embodiments of the invention, and by the drawing.

The drawings show in:

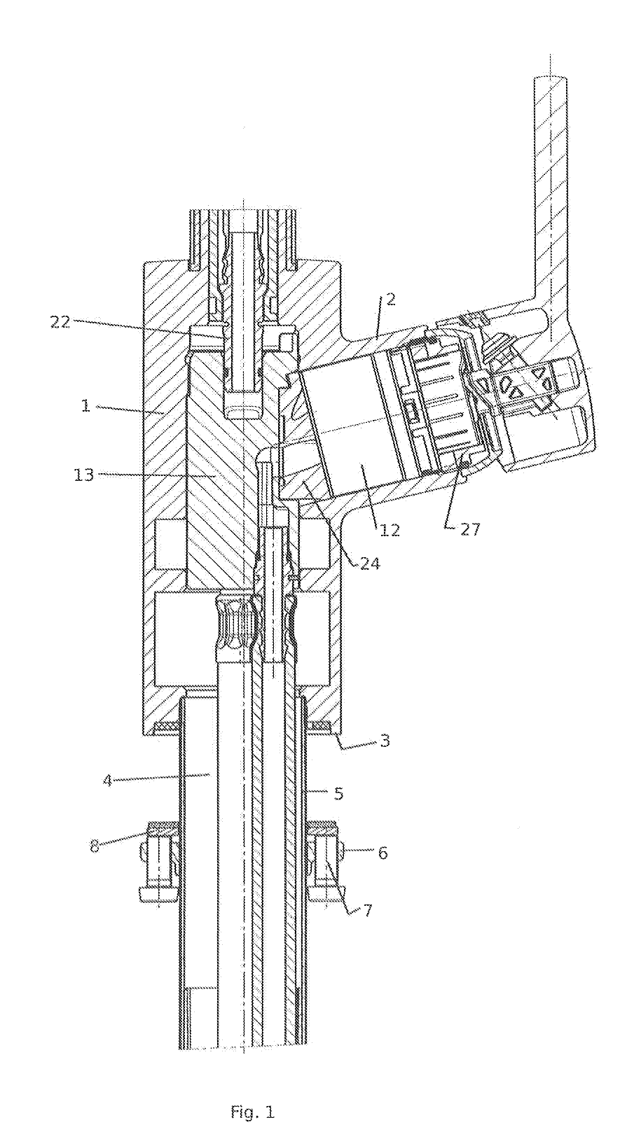

FIG. 1 an axial section through a sanitary fitting according to the invention;

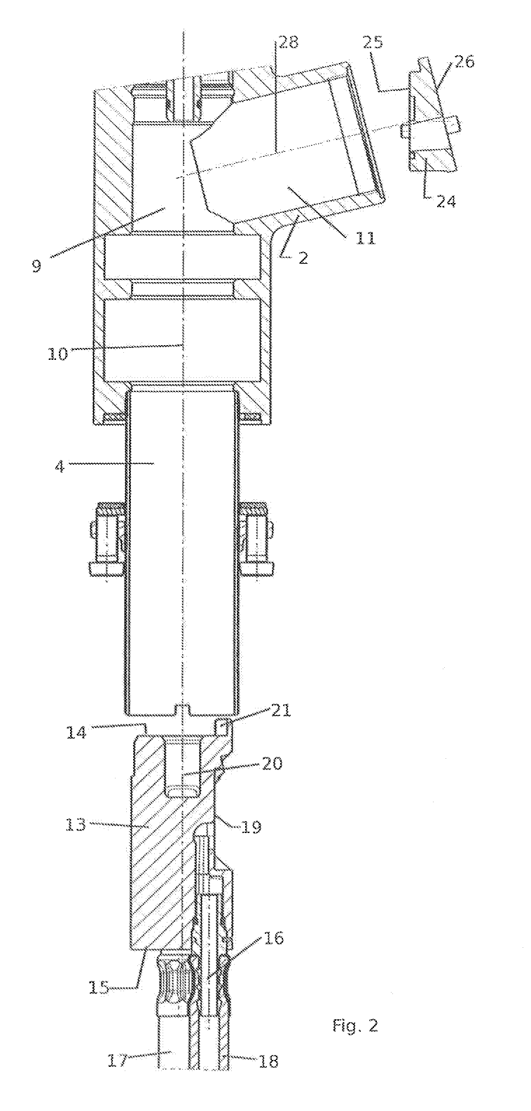

FIG. 2 an axial section through the individual parts of the sanitary fitting;

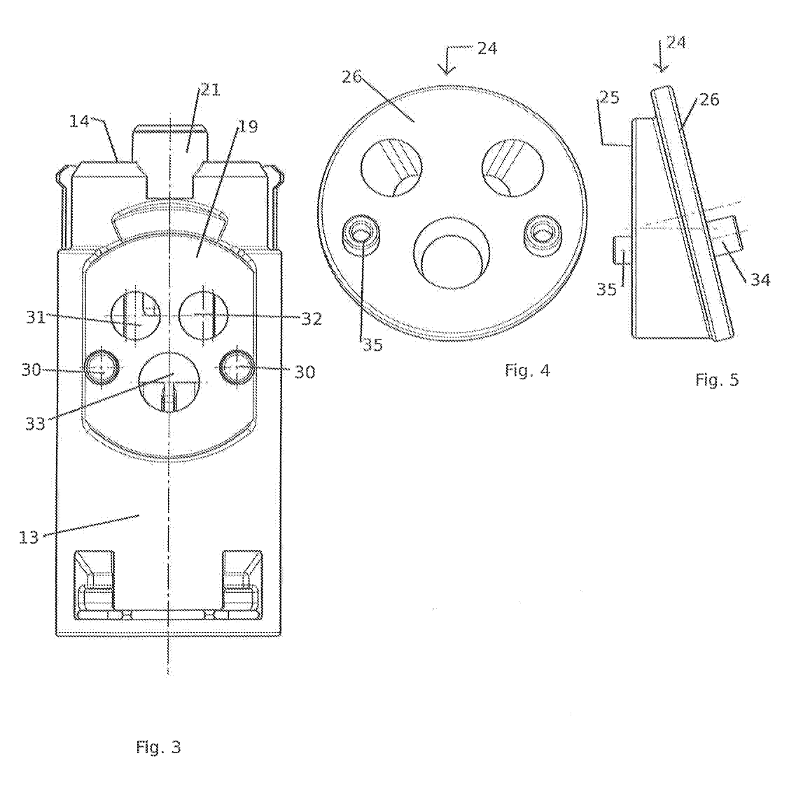

FIG. 3 a side view of the connecting insert from the side of the receptacle for the mixer cartridge;

FIG. 4 a front view of the adapter insert in an enlarged scale;

FIG. 5 a side view of the adapter insert in FIG. 4;

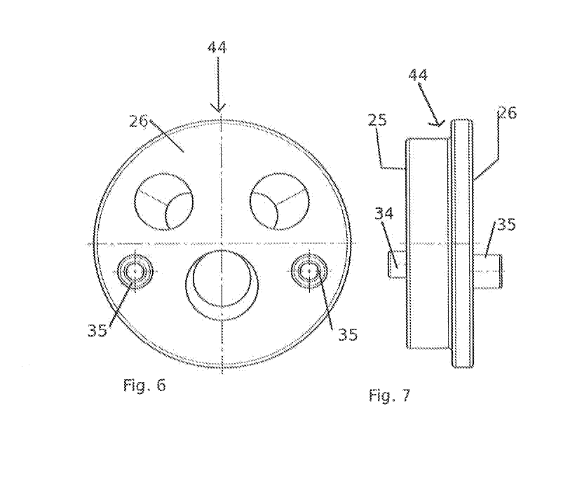

FIG. 6 a front view corresponding to FIG. 4 of an adapter insert of a further embodiment;

FIG. 7 a view corresponding to FIG. 5 of the adapter insert in FIG. 6.

FIGS. 1 and 2 can be described together. The sanitary fitting shown in section contains a fitting housing 1 having a cylindrical outer form with a branch 2. On its underside 3, the housing forms a fastening surface using which it can be fastened for example for a flat and horizontal base. A sleeve 4 having a thread 5 on its outside is screwed into the fitting housing 1. A plate 6 having several axial screws 7 is screwed into the thread. The screws 7 engage at their upward facing end in a plate 8 surrounding the sleeve 4. The fitting housing 1 can be screwed tight to a horizontally oriented plate by turning the plate 6 and tightening the screws 7. This type of fastening is known.

An interior 9 having a straight-line central axis 10 is formed inside the fitting housing 1.

A receptacle 11 for a mixer cartridge 12 is formed in the obliquely provided branch 2.

A connecting insert 13 substantially filling the upper part of the interior 9 is inserted into the interior 9. The connecting insert 13 extends with its upper end face 14 in the final position shown in FIG. 1 beyond the opening of the receptacle 11 into the interior 9.

Two connections 16 each for one supply line hose 17, 18 are arranged on the lower end face 15 of the connecting insert 13. The connections 16 are linked to ducts inside the connecting insert 13. These ducts open in a separation surface 19 oriented on the right in FIG. 1 and FIG. 2.

The connecting insert 13 has on its upper end face 14, i.e. that facing away from the connections 16 for the supply line hoses 17, 18, a plug-in connection 20 in the form of a recess. Beside this recess, the connecting insert 13 has a projection 21 provided in the edge area of the end face 14. The projection 21 forms an orientation aid for correct angular alignment of the connecting insert 13 in the interior 9 of the fitting housing 1.

At the upper end of the interior 9, a plug-in nipple 22 is provided that projects into the interior of the interior 9. The plug-in nipple 22 corresponds in its orientation and size to the recess of the connecting insert 13 forming the plug-in connection 20.

The connecting insert 13 connected to the supply line hoses 17, 18 is pushed through the inside of the threaded sleeve 4 into the interior 9, with the projection 21 permitting its angular orientation. It is pushed in until the projection 21 is up against a step provided at the upper end of the interior 9. In this position, the plug-in nipple 22 engages in the plug-in connection 20. Hence the connecting insert is correctly positioned inside the fitting housing 1.

In this position, the already mentioned separation surface 19 is behind the receptacle 11 for the mixer cartridge. Next, an adapter insert 24 is now inserted through the branch 2 and the receptacle 11. The adapter insert 24 has a separation surface 25 facing the connecting insert 13 and flat in the case, and an opposite separation surface 26. Both separation surfaces 25, 26 are at an angle differing from zero, so that the adapter insert 24 viewed from the side, see FIG. 2, seems wedge-shaped. The adapter insert 24 is inserted until its separation surface 25 facing the connecting insert 13 is up against the separation surface 19 of the connecting insert 13. The separation surface 19 of the connecting insert 13 is limited at the top and bottom by a step in each case, so that locking of the connecting insert 13 in its correct position is now achieved by insertion of the adapter insert 24.

Then the mixer cartridge 12 is inserted into the receptacle 11 of the housing branch 2 until it is contacting the separation surface 26 of the adapter insert. The mixer cartridge is the fixed in the usual way with a cap nut 27.

The angle between the inner separation surface 25 facing the connecting insert 13 and the outer separation surface 26 of the adapter insert 24 facing the mixer cartridge 12 is selected such that the separation surface 25 can be in flat contact with the separation surface 19 of the connecting insert 13 while the other separation surface 26 is vertical to the longitudinal axis 28 of the receptacle 11.

If a fitting housing is to be used in which the angle of the longitudinal axis 28 of the receptacle 11 for the mixer cartridge differs, a different adapter insert 24 is used accordingly. The connecting insert 13 can however remain identical.

FIG. 4 now shows, in a scale enlarged compared with FIG. 1 and FIG. 2, a side view of the connecting insert 13, from the right in FIGS. 1 and 2. The center of FIG. 3 shows the separation surface 19, which is a flat surface running parallel to the longitudinal axis 10 of the interior 9. Two blind holes 30 used for centering the adapter insert 24 can be seen in this separation surface 19. Furthermore, a total of three openings 31, 32, 33 exit onto this separation surface 19. The openings 31 and 32 are the openings of the ducts connected to the supply line hoses 17, 18 via the connections 16. For example, one opening is intended for cold water and one opening for hot water.

The lower and slightly larger opening 33 leads via a duct inside the connecting insert 13 to the plug-in connection 20. The plug-in connection 20 leads via the plug-in nipple 22 to an outlet from the fitting housing.

FIG. 4 shows, in a scale again enlarged compared with FIG. 3, a view of the adapter insert 24 from its side facing the mixer cartridge 12. The separation surface 26 is therefore shown. Two projections 34 opposite the separation surface 25 are provided in the separation surface 26. They match in their size and arrangement holes in the bottom of the mixer cartridge 12. In addition, the adapter insert contains three continuous ducts which exit as openings in the separation surface 25 and as openings in the separation surface 26. Each exit in the separation surface 25 corresponds to an opening 31 or 32 or 33 in the separation surface 19. In the separation surface 25, the adapter insert likewise contains two projections 35 corresponding to the holes 30.

FIG. 5 shows the adapter insert 24 from the side similarly to FIG. 2, which shows the adapter insert 24 in section.

While the adapter insert 24 in the embodiment of FIGS. 1 to 5 is intended for a fitting housing where the branch 2 with the receptacle 11 is at an angle, FIGS. 6 and 7 show illustrations of an adapter insert 44 for a fitting housing which correspond to FIGS. 4 and 5, where the branch 2 of the fitting housing is at right angles to the longitudinal axis 10 of the interior 9. For this reason, the inward and outward facing separation surfaces 25, 26 of the adapter insert 44 are parallel to one another. This adapter insert 44 can interact with the identical connecting insert 13 of the preceding embodiment.

We claim:

1. A sanitary fitting, comprising:
a fitting housing with a substantially straight-line interior for at least one of supply and discharge lines, wherein the fitting housing has a variant connected to the straight-line interior, the variant diverging from the straight line interior and having a receptacle for a mixer cartridge;
a connecting insert arranged in the straight-line interior, the connecting insert on one end face thereof having a connection at least for one supply line; and,
an adapter insert between the connecting insert and the receptacle for the mixer cartridge.

2. The sanitary fitting according to claim 1, wherein the straight line interior forms a passage and the receptacle for the mixer cartridge is arranged in a side branch of the fitting housing.

3. The sanitary fitting according to claim 1, wherein the connecting insert in the straight-line interior has a lateral separation surface facing the receptacle for the mixer cartridge, the lateral separation surface of the connecting insert being contacted by the separation surface of the adapter insert.

4. The sanitary fitting according to claim 1, wherein the adapter insert forms a bottom for the mixer cartridge.

5. The sanitary fitting according to claim 1, wherein the connecting insert has, on an end face of the connecting insert other than the one end face for the connection at least for the supply line, a connection for a line leading out of the sanitary fitting.

6. The sanitary fitting according to claim 1, wherein the connecting insert is configured for insertion into the fitting housing from a supply line side.

7. The sanitary fitting according to claim 1, wherein the connecting insert is configured to lock with the adapter insert, in position within the sanitary fitting.

8. The sanitary fitting according to claim 5, wherein the connection for the line leading out of the sanitary fitting comprises a plug-in connection.

9. The sanitary fitting according to claim 1, wherein the adapter insert is configured for insertion into the fitting housing through the receptacle for the mixer cartridge.

10. The sanitary fitting according to claim 1, wherein the connecting insert has an alignment aid for correct insertion of the connecting insert into the interior of the fitting housing.

11. The sanitary fitting according to claim 1, wherein at least one of the connecting insert, the adapter insert and the line leading out of the sanitary fitting comprises plastic.

12. A method for angular compensation in a sanitary fitting with a fitting housing receiving a connecting insert along a line in an interior of the sanitary fitting and having a mixing cartridge in a variant on the fitting housing diverging at an angle from the line in the interior, comprising:
placing an adapter insert between the connecting insert and the mixer cartridge, wherein the adapter insert is configured to compensate for said angle.

13. A system of sanitary fittings comprising at least two differing fitting housings characterized by differing arrangements of a mixer cartridge in the fitting housings, wherein at least two differing adapter inserts are each adapted to a respective arrangement of the differing fitting housings such that the mixer cartridges of the differing fitting housings are configured by the differing adapter inserts to couple to water lines through identical connecting inserts.

14. The method of claim 12, further comprising providing at least two fitting housings wherein the variants of the fitting housings diverge from the line in the respective interiors of the fitting housings at different angles, and providing for each of the at least two fitting housings an adapter insert that compensates for the respective angle of the fitting housing.

15. The method of claim 14, wherein the adapter inserts for the at least two fitting housings compensate for the respective angles such that a same connecting insert and a same mixer cartridge can fit into either of the at least two fitting housings.
